(19) United States
(12) Patent Application Publication
(10) Pub. No.: US 2004/0047537 A1
(43) Pub. Date: Mar. 11, 2004

(54) Fan-out circuit with integrated active and passive components

(76) Inventors: Warren Timothy Boord, Brooklyn Park, MN (US); Terry Vanderwert, Inver Grove Heights, MN (US); Anil K. Jain, North Oaks, MN (US)

Correspondence Address: MERCHANT & GOULD PC, P.O. BOX 2903, MINNEAPOLIS, MN, 55402-0903, US

(21) Appl. No.: 10/236,877

(22) Filed: Sep. 6, 2002

(51) Int. Cl. G02B 6/12; G02B 6/26

(52) U.S. Cl. 385/14; 385/15

(57) ABSTRACT

A substantially planar fan-out circuit that receives a set of signals at one end and conducts the signals via a set of waveguides to an opposite end of the circuit. The intensity of at least one of the optical signals is detected with an optical detector integrated into the optical circuit. The detected optical signal is attenuated with a variable optical attenuator integrated into the optical circuit. The variable optical attenuator effects an attenuation level based upon an output of the optical detector. The optical signals are delivered from the second end of the optical circuit, so that the optical signals are either more or less dispersed at the second end of the optical circuit than at the first end.

### FIELD OF THE INVENTION

The invention relates generally to optical networking equipment and components for gain equalization, and more particularly to a fan-out circuit with gain equalization incorporated therein.

### BACKGROUND OF THE INVENTION

Optical networking equipment typically includes passive and active components. Passive stages are oftentimes used for polarizing, multiplexing, demultiplexing, focusing, or otherwise redirecting the optical signals carried by the optical network. The active stages oftentimes are used to amplify the signal, attenuate the signal, or run control circuitry that controls the flow of the optical signals in the network. Active components are often used, for example, to equalize the amplitudes of the various signals carried on the various wavelengths propagating through the network (it is well known in the art that signals carried on different wavelengths tend to experience amplitude discrepancies for a variety of reasons). It is commonplace for active and passive optical components to be segregated, because of their different uses.

Heretofore, the need to equalize the amplitudes of signals carried on different wavelengths (referred to herein as “channel equalization”) has been carried out by discrete active components. One drawback of this approach is that approximately five discrete optical components are needed for each channel needing to be equalized. This proliferation of components is costly and needlessly complex. Furthermore, the existing approach to channel equalization has resulted in network components that are needlessly large.

Traditionally, other functions have also been addressed with discrete components. For example, the need to switch signals between local and express lines in an optical drop/add multiplexer has been addressed via discrete components. This results in the same set of negative consequences.

Based upon the preceding discussion, it is evident that there exists a need to address the problem of channel equalization and/or port switching without greatly increasing the number of discrete components included in the network. A desirable solution may be relatively small in size and susceptible of deployment in a wide variety of networks. Additionally, a desirable solution may result in a cost savings.

### SUMMARY OF THE INVENTION

Against this backdrop the present invention has been developed. An integrated optical circuit capable of solving one or more of the aforementioned problems may include a substrate and a first optical layer having a first refractive index. A second optical layer having a second refractive index and is disposed atop the first optical layer. The second layer is patterned so as to comprise an input waveguide for receiving a multiplexed optical signal. It is also patterned to comprise a set of single-wavelength input waveguides wherein each waveguide within the set receives an optical signal carried on a single wavelength. It is also patterned to comprise an output waveguide for outputting a multiplexed optical signal. Finally, it is patterned to comprise a set of single-wavelength output waveguides, wherein each waveguide within the set outputs an optical signal carried on a single wavelength. A third optical layer having a third refractive index is disposed atop the second optical layer. The refractive index of the third and first optical layers is less than the refractive index of the second optical layer. A variable optical attenuator interposed in each single-wavelength input set of waveguides. Additionally, a directional coupler is interposed in each waveguide within the set of single-wavelength input waveguides, so that a fraction of an optical signal traveling along each waveguide within the set of single-wavelength input waveguides is redirected along the directional coupler. Finally, an optical detector is coupled to each directional coupler. The optical detectors receive the redirected fraction of the optical signal, and generate a detector signal in proportion to intensity of the redirected optical signal. The detector signal is used to control a level of attenuation employed by the variable optical attenuator.

According to another embodiment of the invention, an integrated optical circuit solving one or more of the aforementioned problems may include a substrate having a first end and a second end. A plurality of waveguides extends between the first end and the second end of the substrate. The waveguides are spaced substantially further apart at the second end of the substrate than at the first end of the substrate. A variable optical attenuator is interposed in at least one of the waveguides. Further, a directional coupler is interposed in the waveguide having the variable optical attenuator, so that a fraction of an optical signal traveling along the waveguide is redirected along the directional coupler. Finally, an optical detector is coupled to the directional coupler. The optical detector receives the redirected fraction of the optical signal and generates a detector signal in proportion to intensity of the redirected optical signal. The detector signal is used to control a level of attenuation employed by the variable optical attenuator.

According to yet another embodiment of the present invention a method of dispersing a plurality of optical signals includes receiving a set of signals at one end of an optical circuit and conducting the signals via a set of waveguides to an opposite end of the circuit. The intensity of at least one of the optical signals is detected with an optical detector integrated into the optical circuit. The detected optical signal is attenuated with a variable optical attenuator integrated into the optical circuit. The variable optical attenuator effects an attenuation level based upon an output of the optical detector. The optical signals are delivered from the second end of the optical circuit, so that the optical signals are either more or less dispersed at the second end of the optical circuit than at the first end.

### BRIEF DESCRIPTION OF THE FIGURES

FIG. 1 depicts an embodiment of a fan-out circuit, in accordance with one embodiment of the present invention.

FIG. 2 depicts another embodiment of a fan-out circuit, in accordance with one embodiment of the present invention.

FIG. 3 depicts yet another embodiment of a fan-out circuit, in accordance with one embodiment of the present invention.

FIG. 4 depicts yet another embodiment of a fan-out circuit, in accordance with one embodiment of the present invention.

FIG. 5A depicts an embodiment of a variable optical attenuator that may be used in the fan-out circuits of FIGS. 1-4.

FIG. 5B depicts another embodiment of a variable optical attenuator that may be used in the fan-out circuits of FIGS. 1-4.

FIG. 6 depicts an embodiment of an optical switch that may be used in the fan-out circuits of FIGS. 1-4.

FIG. 7 depicts an embodiment of an optical amplifier that may be used in the fan-out circuits of FIGS. 1-4.

### DETAILED DESCRIPTION

The initial stage of optical networking equipment often includes a fan-out circuit, which is a substantially planar circuit that receives a set of signals at one end and conducts the signals via a set of waveguides to an opposite end of the circuit. The signals are inputted to and outputted from a fan-out circuit via ports. The ports on one side of the circuit are much closer together than at the other end. Thus, a fan-out circuit permits butt joining of a set of fibers to the end at which the ports are relatively spread out. A fan-out circuit may be found at the front end of an optical drop/add multiplexer or a dynamic gain equalizer, for example.

With respect to a fan-out circuit, the essential job of spreading out (or squeezing together) various optical signals is accomplished by passive circuitry. However, certain active elements may be introduced into a fan-out circuit. By including a directional coupler, an optical detector, and a variable optical attenuator into a fan-out circuit, channel equalization can be addressed. By adding an optical switch therein, the need for switching signals between local and express lines can be met. The above-described arrangement may be used to create an optical add/drop multiplexer or a dynamic gain equalizer, for example.

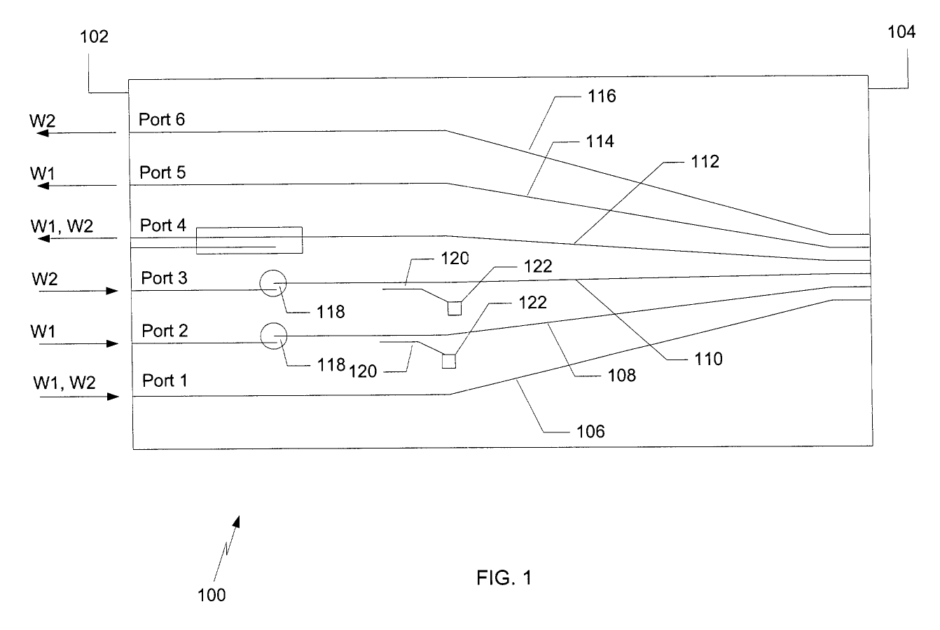

The discussion related to FIGS. 1-7 describes with more detail the fan-out circuit and its integrated active components. Schemes for utilizing the fan-out circuit in an optical add/drop multiplexer or in a dynamic gain equalizer are also disclosed in the discussion related to FIGS. 1-7. Other uses for the fan-out circuit described herein will readily suggest themselves to one of ordinary skill in the art, and are within the scope of this application.

FIG. 1 depicts a fan-out circuit 100 in accordance with one embodiment of the present invention. For the sake of simplicity, the fan-out circuit 100 is depicted according to a scheme in which it is used at the front end of a dynamic gain equalizer that receives and equalizes only two channels of information, carried on wavelengths W1 and W2 (in a typical network application, many more than two channels are utilized).

As can be seen from FIG. 1, the fan-out circuit contains six ports, each of which is labeled “Port 1,” “Port 2,” etc. At ports 1-3, optical signals are inputted to the fan-out circuit 100, while at ports 4-6, optical signals are outputted from the fan-out circuit 100, as is indicated by the directional arrows located by each port.

The fan-out circuit 100 has a first end 102 at which the ports are spaced relatively far apart, and also has a second end 104 at which the ports are spaced relatively close together. Accordingly, the ports located at the first end 102 of the fan-out circuit 100 can be butt joined to optical fibers for inputting or outputting of signals. Waveguides 106-116 extend from the first end 102 of the fan-out circuit 100 to the second end 104. Thus, a signal received at one end of the fan-out circuit 100 is propagated to the other end via the waveguide 106 into which the signal was introduced.

The waveguides 106-116 are composed of paths, which are printed atop a first optical layer having a refractive index, n_{L}. The waveguides 106-116 have a refractive index of n_{H}, wherein n_{H}>n_{L}. A second optical layer also having a refractive index of n_{L} is disposed atop the waveguides. Thus, the waveguides 106-116 are surrounded by material having a refractive index less than the refractive index of the waveguides 106-116, themselves. Consequently, an optical signal propagating through one of the waveguides 106-116 will be reflected at the boundary between the waveguide 106 and the surrounding material, meaning that the optical signal is effectively confined to traveling in an axial direction along the waveguide 106-116, remaining always within the interior region of the waveguide 106-116.

Assuming the fan-out circuit of FIG. 1 is to be deployed in a dynamic gain equalizer, the fan-out circuit 100 is used as follows. Port 1 provides access to a waveguide 106 for receiving a multiplexed optical signal. Thus, the optical signal propagated along waveguide 106 contains many wavelengths. For purposes of illustration, it is assumed that the optical signal inputted at port 1 contains two wavelengths, W1 and W2.

The multiplexed signal inputted at port 1 is conducted to the second end 104 of the fan-out circuit 100, whereupon it is inputted to a demultiplexing system. An example of a demultiplexing circuit is disclosed in U.S. application Ser. No. 09/625,935, entitled “MULTIPLEXER, DEMULTIPLEXER and ADD/DROP MULTIPLEXER FOR SINGLE MODE OPTICAL FIBER COMMUNICATION LINKS,” which is hereby incorporated by reference for all it teaches. The demultiplexing system separates the optical signal into its constituent wavelengths, and delivers each demultiplexed signal to a separate port at the second end 104 of the fan-out circuit 100. In this example, wavelength W1 is input to port 5, and is therefore propagated from the second end 104 of the fan-out circuit 100 to the first end 102 via waveguide 114. Wavelength W2 is input to port 6, and is propagated from the second end 104 of the fan-out circuit to the first end 102 via waveguide 116.

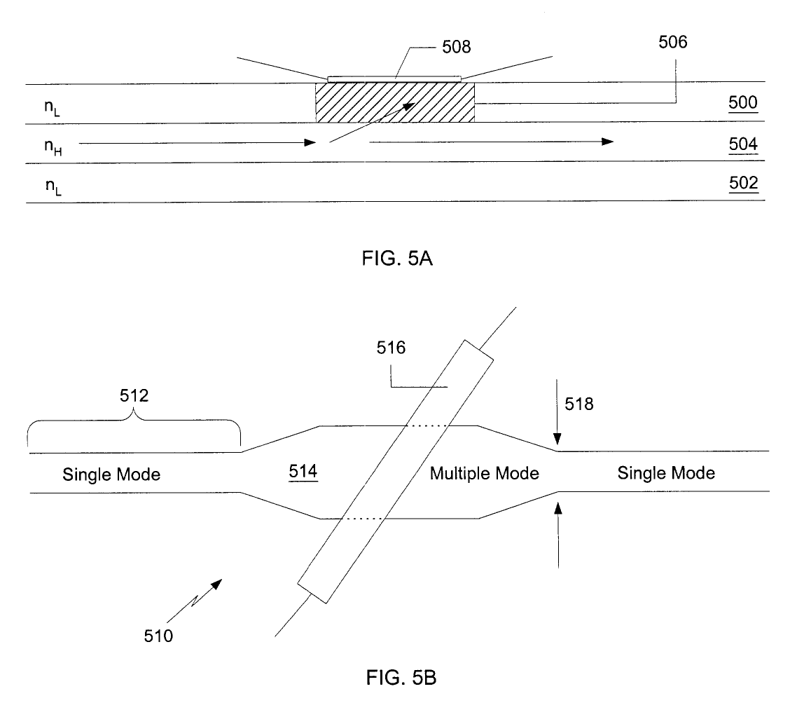

When the fan-out circuit 100 is deployed as part of a dynamic gain equalizer (as is the case in FIG. 1), an optical fiber loop (not depicted) is used to couple port 5 to port 2 and port 6 to port 1. Thus, each of the constituent wavelengths is returned to the fan-out circuit 100. With respect to the signal carried on wavelength W1, it is carried by waveguide 108 to a variable optical attenuator 118. Similarly, the signal carried on wavelength W2 is carried by waveguide 110 to another variable optical attenuator 118. A variable optical attenuator 118 receives an optical signal and attenuates its strength in accordance with a control signal. The discussion related to FIGS. 5A and 5B discloses exemplary embodiments of a variable optical attenuator. Accordingly, the optical attenuator 118 interposed in waveguide 108 receives the signal carried on wavelength W1 and attenuates the signal according to a control signal (discussed below). The optical attenuator 118 interposed in waveguide 110 receives the signal carried on wavelength W2 and attenuates the signal according to a control signal (also discussed below).

After attenuation, the optical signal carried on wavelength W1 is propagated toward a directional coupler 120, which re-directs a fraction of the optical signal toward an optical detector 122. The optical detector 122 generates a detector signal that is approximately proportional to the magnitude of the optical signal incident upon it. For example, the optical detector may include a semiconductor pin photodiode. Light absorbed in the semiconductor produces hole—electron pairs. Pairs produced in or near the semiconductor junction depletion region are separated by the electric field, leading to current flow in the external circuit as carriers drift across the depletion layer. Thus, the detector signal generated by optical detector is proportional to the magnitude of the optical signal carried on wavelength W1. The detector signal may be supplied to control circuitry (not depicted), which may be embodied on a separate integrated circuit. For example, the control circuit may be embodied on a microprocessor running software code designed to yield an appropriate control signal. Alternatively, the control circuit may be embodied on an application-specific integrated circuit (ASIC). The control circuit generates a control signal, based upon the detector signal, and delivers the control signal to the optical attenuator 118, which determines its attenuation level therefrom. Thus, the optical attenuators 118 attenuate their respective optical signals based upon the measured strength of each signal.

The optical signals carried on wavelengths W1 and W2 eventually reach the second end 104 of the fan out circuit 100, whereupon they are provided to a multiplexing system, such as the multiplexing system disclosed in U.S. application Ser. No. 09/625,935. The multiplexing system combines the signals carried on the various wavelengths, in this case W1 and W2, and returns a single multiplexed optical signal, which is provided to port 4. The multiplexed signal is propagated from the second end 104 of the fan-out circuit 100 to the first end 102 along waveguide 112.

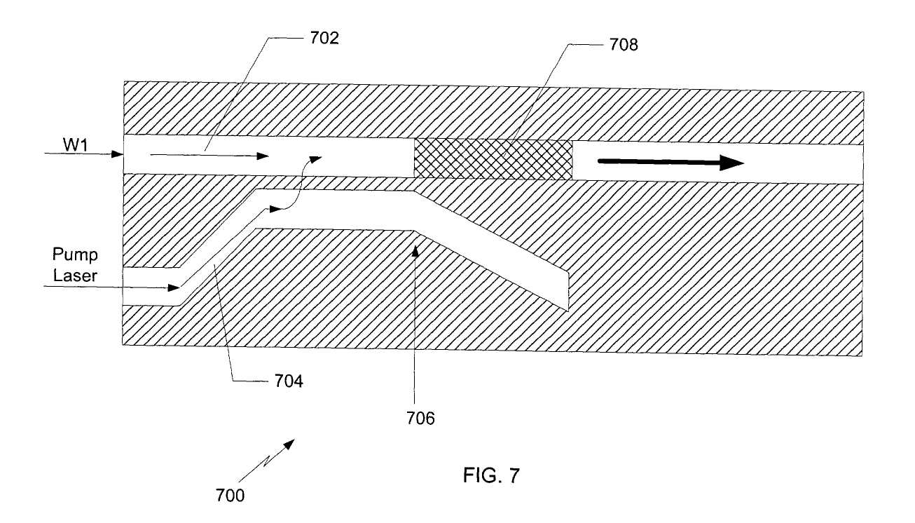

As depicted in FIG. 1, an optical amplifier 124 is interposed in waveguide 112. Optionally, the optical amplifier 124 may be connected in series with the output from port 4, and may be embodied as a discrete active component. The optical amplifier receives the multiplexed signal and amplifies its magnitude, delivering the amplified signal to port 4 on the first end 102 of the waveguide 100. The discussion related to FIG. 7 discloses an exemplary embodiment of an optical amplifier. The optical amplifier 124 may apply different gain factors to the signals carried on the different wavelengths. Since the goal of a dynamic gain equalizer is to yield a multiplexed signal in which all wavelengths exhibit the same magnitude, the optical attenuators 118 are controlled so as to compensate for the wavelength-dependant gain factor. In other words, for wavelengths that are amplified with a relatively high gain factor, the optical attenuators 118 apply a relatively high attenuation factor. Conversely, for wavelengths that are amplified with a relatively low gain factor, the optical attenuators 118 apply a relatively low attenuation factor. The functionality to compensate for the gain profile of the optical amplifier 124 is embodied in the control circuitry (not depicted). The net result of the above-described arrangement is that the multiplexed signal emanating from output port 4 is composed of signals of multiple wavelengths, with each constituent signal having substantially identical amplitudes.

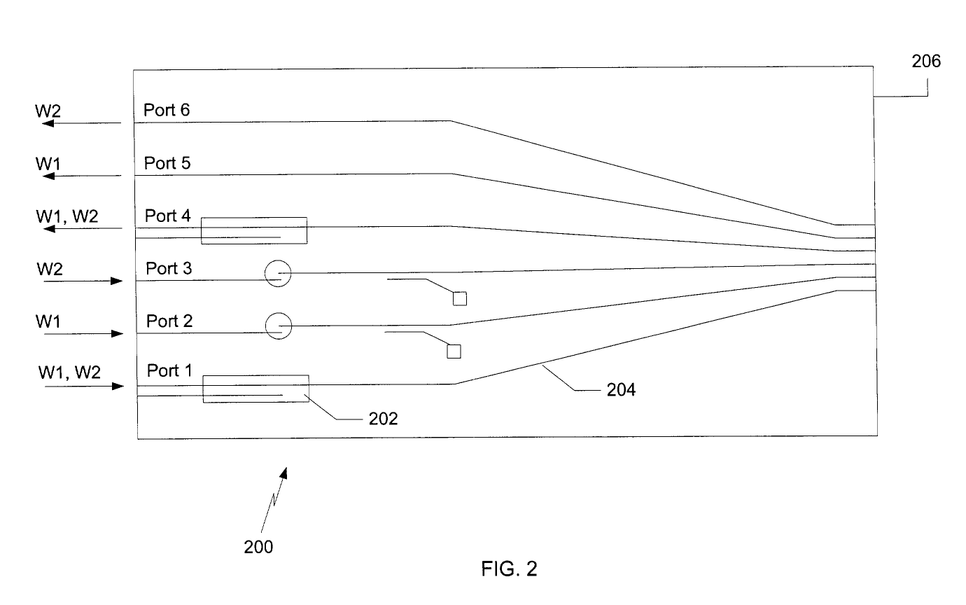

FIG. 2 depicts a fan-out circuit 200 similar to the fan-out circuit 100 depicted in FIG. 1, with one additional element: an optical amplifier 202 is interposed in the waveguide 204 used for receiving a multiplexed optical signal. The optical amplifier 204 receives a multiplexed signal and amplifies its magnitude, delivering the amplified signal to the second end 206 of the fan-out circuit 200. As was the case with the optical amplifier 124 of FIG. 1, the optical amplifier 202 may apply differing gain values to signals carried on various wavelengths. The purpose of the optical amplifier 202 is to amplify the incoming multiplexed signal to a magnitude sufficient for detection by the optical detectors 122 (some optical detectors cannot detect an optical signal with a magnitude beneath a certain threshold).

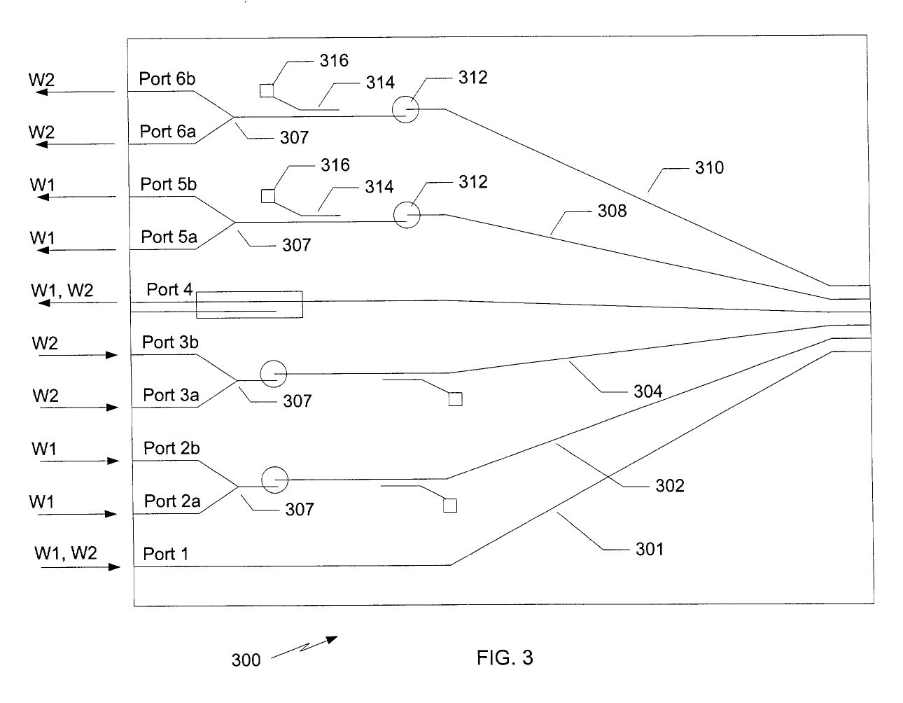

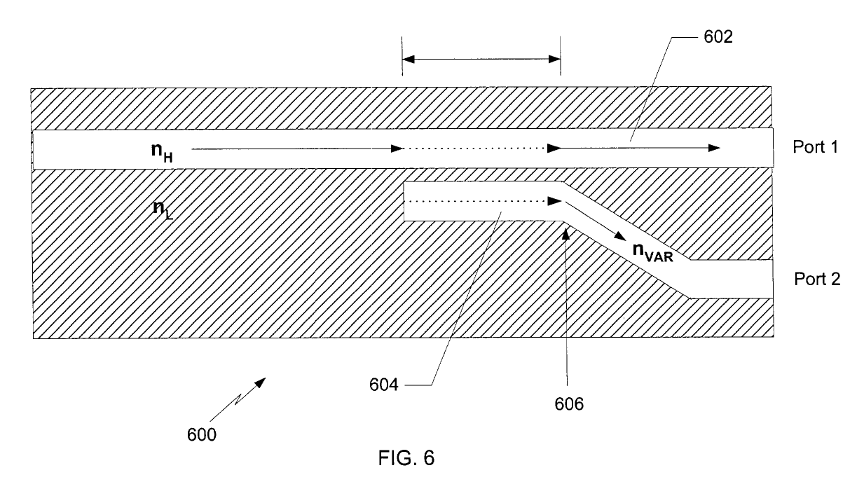

FIG. 3 depicts an embodiment of the fan-out circuit 300, with switching capability integrated therein. The fan-out circuit 300 of FIG. 3 may be used as part of an optical add/drop multiplexer. An optical add/drop multiplexer is deployed in a network setting that includes a long haul fiber backbone that is used for transmitting information over long spans of distance. Optical signals propagating along the long haul fiber backbone eventually reach the optical add/drop multiplexer, which may perform one of three tasks: (1) it may simply re-transmit a signal along the long haul fiber backbone to the next optical drop/add multiplexer; (2) it may “drop” a signal to a local network, in which case the signal is transmitted to a local network, rather than being kept on the long haul fiber backbone; or (3) a signal may be “added” to the long haul fiber backbone from a local network. The signals may be amplified and/or channel equalized during the course of any of these three tasks. As a consequence of these tasks, a single-wavelength input waveguide, such as waveguide 302 or 304 may be carrying a signal for re-multiplexing by virtue of performing its role of re-transmitting a signal along the long haul fiber backbone, or by virtue of performing its role of “adding” a signal from a local network. Thus, each single-wavelength input waveguide 302 and 304 can receive signals from two ports. For example, waveguide 302 can receive a signal from port 2a (an “a” port) or 2b (a “b” port). Similarly, waveguide 304 can receive a signal from port 3a (an “a” port) or 3b (a “b” port). An optical switch 306 determines whether the waveguides 302 or 304 are receiving a signal from their respective “a” port or “b” port. This discussion related to FIG. 6 discloses an exemplary embodiment of an optical switch. Each “a” port is connected via a fiber loop (not shown) to a single-wavelength output port (e.g., port 5a is connected to port 2a, and port 6a is connected to port 3a). Thus, signals that are to be re-transmitted along the long-haul optical fiber backbone traverse the following ports: they are received at port 1 and propagate along waveguide 301, are transmitted to a demultiplexer, transmitted along waveguide 308 to port 5a (if carried on wavelength W1) or along waveguide 310 to port 6a (if carried on wavelength W2), transmitted via a fiber loop to port 2a (if carried on wavelength W1) or port 3a (if carried on wavelength W2), transmitted to a multiplexer, and re-transmitted from port 4 to the long-haul fiber backbone. The optical switches 307 interposed in the single-wavelength output waveguides 308 and 310 ensure that the signals are transmitted to the “a” ports (for reentry into the fan-out circuit via the fiber loop), as opposed to the “b” ports (which lead to the local network).

Signals that are to be dropped to the local network traverse the following ports: they are received at port 1 and propagate along waveguide 301, are transmitted to a demultiplexer, transmitted along waveguide 308 to port 5b (if carried on wavelength W1) or along waveguide 310 to port 6b (if carried on wavelength W2). Ports 5b and 6b are both connected to the local network. The optical switches 307 interposed in the single-wavelength output waveguides 308 and 310 ensure that the signals are transmitted to the “b” ports (which lead to the local network), instead of the “a” ports (which lead to the fiber loop).

Signals that are to be added to the long haul fiber backbone are received on ports 2b (if carried on wavelength W1) or 3b (if carried on wavelength W2), transmitted to a multiplexer, and re-transmitted from port 4 to the long-haul fiber backbone. The optical switches 307 interposed in the single-wavelength input waveguides 302 and 304 ensure that the signal are received from the “b” ports, which are connected to the local network, as opposed to the “a” ports, which are connected to the fiber loop.

In the embodiment of FIG. 3, the fan-out circuit 300 contains additional active elements interposed in the single-wavelength output waveguides 308 and 310. Specifically, an optical attenuator 312 is interposed in each waveguide 308 and 310. As described above, these optical attenuators receive a signal and attenuate it according to a control signal. The control signals are based upon detector signals generated by optical detectors 316, which are connected to directional couplers 314 that re-direct a fraction of the optical signal toward the optical detectors 316. The purpose of interposing these active elements into the single-wavelength output waveguides 308 and 310 is to ensure that signals dropped to the local network exhibit magnitudes that are attenuated to substantially equal magnitudes from wavelength to wavelength. Further, the active elements may ensure that the signals are of appropriate magnitude for the local network.

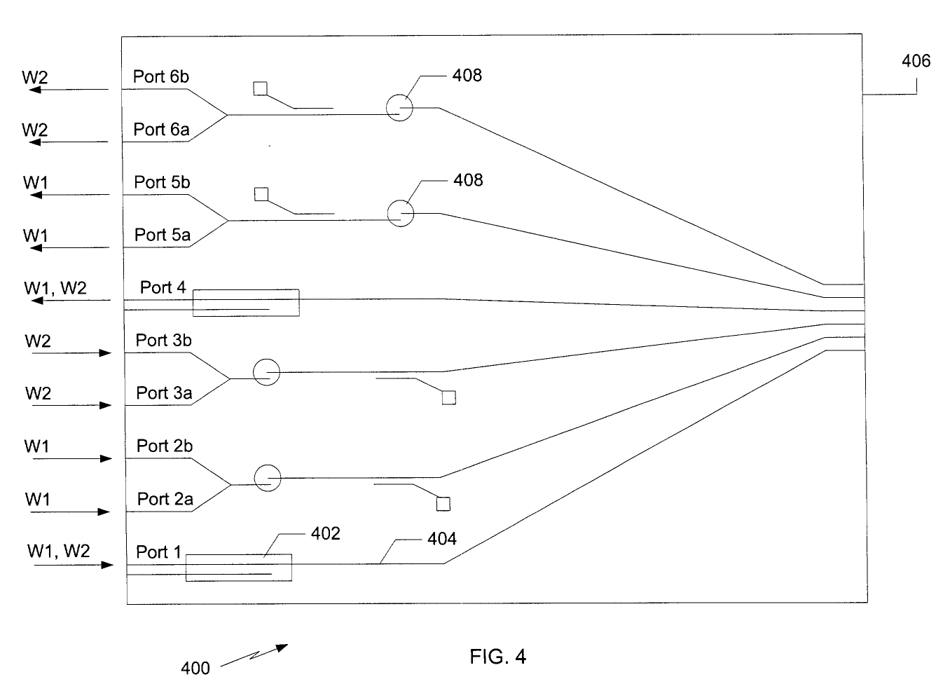

FIG. 4 depicts a fan-out circuit 400 similar to the fan-out circuit 300 depicted in FIG. 3, with one additional element: an optical amplifier 402 is interposed in the waveguide 404 used for receiving a multiplexed optical signal. The optical amplifier 402 receives a multiplexed signal and amplifies its magnitude, delivering the amplified signal to the second end 406 of the fan-out circuit 400. Again, the optical amplifier 402 may apply differing gain values to signals carried on various wavelengths. One purpose of the optical amplifier 402 is to amplify the incoming multiplexed signal to a sufficient magnitude for detection by the optical detectors (some optical detectors cannot detect an optical signal with a magnitude beneath a certain threshold). Another purpose of the optical amplifier 402 is to provide a source of amplification for signals that are to be dropped to the local network via ports 5b and 6b. As was discussed with reference to FIG. 1, the optical amplifier 402 and variable optical attenuators 408 cooperate to yield signals that are of constant magnitude from wavelength to wavelength. For example, if the optical amplifier 402 applies a relatively high gain factor to a signal, the variable optical attenuator 408 applies a relatively high attenuation level, and vice versa.

FIG. 5A depicts one embodiment of a variable optical attenuator, which is shown in a side view. The variable optical attenuator of FIG. 5A may be used in the fan-out circuits depicted in FIGS. 1-4. Other variable optical attenuators are known in the art and may be used in the fan-out circuits depicted in FIGS. 1-4, as well. The variable optical attenuator includes first and second optical layers 500 and 502, which have a refractive index of n_{L}. Sandwiched in between layers 500 and 502 is optical layer 504, which has a refractive index of n_{H} (wherein n_{H}>n_{L}), and is responsible for carrying the optical signal. Thus, by virtue of the discrepant refractive indices, an optical signal propagating through layer 504 will be reflected when it encounters layer 500 or 502, meaning that it will be effectively confined to propagating axially through layer 504. However, a thermo-optic polymer 506, such as acrylate, is introduced into layer 500. The thermo-optic region 506 exhibits a trait whereby its refractive index increases with temperature. A heating element 508, such as a conductive path, is juxtaposed to the thermo-optic region 506. By supplying the heating element 508 with an electric current, the temperature of the thermo-optic region 506 is elevated, causing a concomitant rise in the refractive index of the region 506. As the refractive index of the thermo-optic region 506 approaches the refractive index of layer 504, an increasing fraction of the optical signal is transmitted into the thermo-optic region 506, rather than being reflected back into region 504. Therefore, by driving an electrical current through the heating element 508, control is gained over the amount of optical energy lost to the thermo optic region 506. Consequently, the structure of FIG. 5A attenuates the signal traveling through layer 504 in accordance with an electrical current supplied to the heating element 508. Accordingly, the electrical current supplied to the heating element 508 acts as the “control signal” that determines the attenuation level of the variable optical attenuator.

FIG. 5B depicts another embodiment of a variable optical attenuator, which is shown in a top view. The variable optical attenuator of FIG. 5B may be used in the fan-out circuits depicted in FIGS. 1-4. Other variable optical attenuators are known in the art and may be used in the fan-out circuits depicted in FIGS. 1-4, as well. The variable optical attenuator includes a waveguide 510 that has a first region 512 that has a width, w1, that permits only a single mode of the optical signal to be transmitted through region 512. Juxtaposed to region 512 is a broader region 514, which is capable of conducting two or more modes of the optical signal. A heating element 516 extends across the top of the broad region 514. When an electric current is driven through the heating element 516, the temperature of the portion of the broad region 514 beneath the heating element 516 is elevated. Importantly, the waveguide 510 is made of a thermo-optic polymer, such as acrylate, which has a refractive index that is a function of temperature. When a current is driven through heating element 516, the temperature of the portion of the broad region 514 beneath the heating element 516 is elevated, meaning that that region exhibits an abnormally elevated refractive index. Consequently, as an optical signal passes through the region with an abnormally elevated refractive index, its energy becomes divided among a plurality of modes. However, as the individual modes continue to propagate through the waveguide 514, they encounter a point of restriction 518. At the point of restriction 518, the waveguide 510 returns to its original width, meaning that only a single mode can pass. Accordingly, the energy in the higher-order modes is dissipated into surrounding layers, because the higher-order modes are unable to pass the point of restriction 516. In summary, the structure of FIG. 5B attenuates the signal traveling through the waveguide 510 in accordance with an electrical current supplied to the heating element 516. Accordingly, the electrical current supplied to the heating element 516 acts as the “control signal” that determines the attenuation level of the variable optical attenuator.

FIG. 6 depicts an embodiment of an optical switch 600, which is shown in top view. The optical switch of FIG. 6 may be used in the fan-out circuits depicted in FIGS. 1-4. Other switches are known in the art and may be used in the fan-out circuits depicted in FIGS. 1-4, as well. The optical switch 600 includes a first waveguide 602 and a second waveguide 604. The waveguides 602 and 604 are made from a thermo-optic polymer, such as acrylate, which exhibits a trait whereby its refractive index varies as a function of temperature. As can be seen from FIG. 6, waveguides 602 and 604 run parallel to each other until a point of departure 606 is reached. Thereafter, waveguide 604 departs from waveguide 602, and the distance between the two waveguides 602 and 604 grows larger.

A signal propagating along waveguide 602 continues to propagate along waveguide 602 if the index of refraction of the waveguide 604 is adjusted so as to differ from the refractive index of waveguide 602 by a specific amount, which depends upon the waveguide dimensions and separation, the light wavelength, and the refractive indices of the waveguides and the surrounding medium. However, as the index of refraction of waveguide 604 approaches that of waveguide 602 (n_{VAR}≈n_{H}), the energy of the optical signal is alternately carried in waveguide 602 and waveguide 604. This alternation occurs only if waveguide 604 is positioned close enough to waveguide 602, so that waveguide 604 receives a portion of the evanescent light from waveguide 602. Prior to the point of departure, waveguides 602 and 604 are sufficiently close so that the evanescent light yielded by one waveguide is captured by the other waveguide. The aforementioned alternation between waveguides 602 and 604 is periodic, with the period being determined by the refractive indices of the two waveguides 602 and 604 and the surrounding media, the waveguide dimensions and separation, and the guided light wavelength. By controlling the temperature of waveguide 604, the refractive index can be made to attain a value, such that the energy is carried by waveguide 604 at the point of departure 606. Thereafter, as the optical wave continues to propagate along waveguide 604, it cannot return to waveguide 602, because the distance between the two waveguides 602 and 604 is too great. Accordingly, by controlling the refractive index of waveguide 604, an optical signal traveling along waveguide 602 can be made to either: (1) continue traveling along waveguide 602 to port 1; or (2) jump to waveguide 604 and travel to port 2.

FIG. 7 depicts an optical amplifier 700, which is shown in top view. The optical amplifier of FIG. 7 may be used in the fan-out circuits depicted in FIGS. 1-4. Other optical amplifiers are known in the art and may be used in the fan-out circuits depicted in FIGS. 1-4, as well. The optical amplifier 700 includes a first waveguide 702 and a second waveguide 704. Light from a pump laser is directed into waveguide 704. Like the optical switch depicted in FIG. 6, the two waveguide 702 and 704 run parallel to each other until a point of departure. Also like the optical switch depicted in FIG. 6, as the laser beam travels through waveguide 704, its energy is alternately carried by waveguide 702 and waveguide 704, while the waveguides 702 and 704 are sufficiently close together. The point of departure 706 is chosen so that the energy of the laser beam is carried by waveguide 702 at the point of departure 706. Thus, thereafter, the pump laser beam continues to propagate along waveguide 702, and cannot return to waveguide 704.

Waveguide 702 contains a doped region 708. The doped region contains impurities, such as erbium, the electrons of which climb to a higher energy level in response to interaction with the photons from the pump laser beam. Shortly thereafter, the electrons revert to a quasi-stable energy level, where they remain until they are interacted upon by the optical signal (carried on wavelength W1, for example) initially traveling along waveguide 702. Upon interaction, the electron reverts to a lower energy level, emitting a photon having a wavelength of W1, thereby increasing the number of photons having a wavelength of W1, and therefore increasing the amplitude of the optical signal traveling along waveguide 702.

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, other forms of variable optical attenuators, optical switches, directional couplers, and photo detectors may be used. Additionally, the fan-out circuit may be used in other forms of optical equipment. Numerous other changes may be made which will readily suggest themselves to those skilled in the art and which are encompassed in the invention disclosed and as defined in the appended claims.

The claimed invention is:

1. An integrated optical circuit comprising:
a substrate;
a first optical layer having a first refractive index;
a second optical layer having a second refractive index and being disposed atop the first optical layer, wherein the second layer is patterned so as to comprise an input waveguide for receiving a multiplexed optical signal, a set of single-wavelength input waveguides wherein each waveguide within the set receives an optical signal carried on a single wavelength, an output waveguide for outputting a multiplexed optical signal, and a set of single-wavelength output waveguides wherein each waveguide within the set outputs an optical signal carried on a single wavelength;
a third optical layer having a third refractive index, the third layer being disposed atop the second optical layer, the refractive index of the third and first optical layers being less than the refractive index of the second optical layer;
a variable optical attenuator interposed in each single-wavelength input set of waveguides;
a directional coupler interposed in each waveguide within the set of single-wavelength input waveguides, so that a fraction of an optical signal traveling along each waveguide within the set of single-wavelength input waveguides is redirected along the directional coupler; and
an optical detector coupled to each directional coupler, receiving the redirected fraction of the optical signal, and generating a detector signal in proportion to intensity of the redirected optical signal, the detector signal being used to control a level of attenuation employed by the variable optical attenuator.

2. The integrated optical circuit of claim 1, further comprising:
an optical amplifier interposed in the output waveguide for outputting a multiplexed optical signal.

3. A dynamic gain equalizer comprising:
the integrated optical circuit of claim 1;
an optical amplifier connected to the output waveguide for outputting a multiplexed optical signal, so that the optical amplifier receives the outputted multiplexed signal and amplifies each wavelength contained therein; and
a control circuit that determines an attenuation level of the variable optical attenuators, based upon the signal detector signal from the optical detectors;
wherein, the control circuit adjusts the attenuation level of the variable optical attenuators so that each wavelength yielded by the optical amplifier has substantially equal magnitude.

4. A dynamic gain equalizer comprising:
the integrated optical circuit of claim 1;
an optical amplifier interposed in the output waveguide for outputting a multiplexed optical signal, so that the optical amplifier receives the multiplexed signal to be outputted and amplifies each wavelength contained therein; and
a control circuit that determines an attenuation level of the variable optical attenuators, based upon the signal detector signal from the optical detectors;
wherein, the control circuit adjusts the attenuation level of the variable optical attenuators so that each wavelength yielded by the optical amplifier has substantially equal magnitude.

5. The integrated optical circuit of claim 1, further comprising:
an optical amplifier interposed in the input waveguide for receiving a multiplexed optical signal.

6. The integrated optical circuit of claim 2, further comprising:
an optical amplifier interposed in the input waveguide for receiving a multiplexed optical signal.

7. The integrated optical circuit of claim 1, further comprising:
an optical switch interposed in each of the waveguides of the set of single-wavelength input waveguides, so that each waveguide may select whether to conduct a signal from a first or second input fiber; and
an optical switch interposed in each of the waveguides of the set of single-wavelength output waveguides, so that each waveguide may select whether to output a signal to a first or second output fiber.

8. The integrated optical circuit of claim 7, further comprising:
an optical amplifier interposed in the input waveguide for receiving a multiplexed optical signal.

9. The integrated optical circuit of claim 7, further comprising:
a variable optical attenuator interposed in each single-wavelength output set of waveguides;
a directional coupler interposed in each waveguide within the set of single-wavelength output waveguides, so that a fraction of an optical signal traveling along each waveguide within the set of single-wavelength output waveguides is redirected along the directional coupler; and
an optical detector coupled to each directional coupler, receiving the redirected fraction of the optical signal, and generating a detector signal in proportion to intensity of the redirected optical signal, the detector signal being used to control a level of attenuation employed by the variable optical attenuator.

10. The integrated optical circuit of claim 1, further comprising:
a variable optical attenuator interposed in each single-wavelength output set of waveguides;
a directional coupler interposed in each waveguide within the set of single-wavelength output waveguides, so that a fraction of an optical signal traveling along each waveguide within the set of single-wavelength output waveguides is redirected along the directional coupler; and
an optical detector coupled to each directional coupler, receiving the redirected fraction of the optical signal, and generating a detector signal in proportion to intensity of the redirected optical signal, the detector signal being used to control a level of attenuation employed by the variable optical attenuator.

11. The integrated optical circuit of claim 1, wherein:
the substrate has a first end and a second end;
the waveguides extend between the first end and the second end; and
the waveguides are spaced substantially further apart at the second end of the substrate than at the first end of the substrate.

12. The integrated optical circuit of claim 3, wherein:
the substrate has a first end and a second end;
the waveguides extend between the first end and the second end; and
the waveguides are spaced substantially further apart at the second end of the substrate than at the first end of the substrate.

13. The integrated optical circuit of claim 4, wherein:
the substrate has a first end and a second end;
the waveguides extend between the first end and the second end; and
the waveguides are spaced substantially further apart at the second end of the substrate than at the first end of the substrate.

14. An optical multiplexer including the integrated optical circuit of claim 1.

15. An optical multiplexer including the integrated optical circuit of claim 11.

16. An optical demultiplexer including the integrated optical circuit of claim 1.

17. An optical demultiplexer including the integrated optical circuit of claim 14.

18. An integrated optical circuit comprising:
a substrate having a first end and a second end;
a plurality of waveguides extending between the first end and the second end of the substrate, the waveguides being spaced substantially further apart at the second end of the substrate than at the first end of the substrate;
a variable optical attenuator interposed in at least one of the waveguides;
a directional coupler interposed in the waveguide having the variable gain amplifier, so that a fraction of an optical signal traveling along the waveguide is redirected along the directional coupler; and
an optical detector coupled to the directional coupler, receiving the redirected fraction of the optical signal, and generating a detector signal in proportion to intensity of the redirected optical signal, the detector signal being used to control a level of attenuation employed by the variable optical attenuator.

19. The integrated optical circuit of claim 18, further comprising:
an optical amplifier interposed in a waveguide that does not have a directional coupler, optical detector, or variable optical attenuator interposed therein.

20. The integrated optical circuit of claim 18, further comprising:
an optical amplifier interposed in two or more of waveguides that do not have a directional coupler, optical detector, or variable optical attenuator interposed therein.

21. The integrated optical circuit of claim 18, further comprising:
an optical switch interposed in the waveguide having the variable gain amplifier, so that a conduction pathway may be established between the waveguide having the variable gain amplifier and either a first or second fiber.

22. The integrated circuit of claim 18, wherein the optical switch is interposed between the second end of the waveguide and either the variable optical attenuator or the directional coupler.

23. An optical multiplexer including the optical circuit of claim 18.

24. An optical demultiplexer including the optical circuit of claim 18.

25. An optical demultiplexer including the optical circuit of claim 23.

26. A method of dispersing and attenuating a plurality of optical signals, the method comprising:
receiving a plurality of optical signals at a first end of an optical circuit;
conducting the plurality of signal toward a second end of the optical circuit with a plurality of waveguides integrated into the optical circuit;
detecting the intensity of at least one of the optical signals with an optical detector integrated into the optical circuit;
attenuating the at least one detected optical signal with a variable optical attenuator integrated into the optical circuit, the variable optical attenuator effecting an attenuation level based upon an output of the optical detector; and
delivering the optical signals from the second end of the optical circuit, so that the optical signals are either more or less dispersed at the second end of the optical circuit than at the first end.

27. The method of claim 26, further comprising:
amplifying at least one of the optical signals with an optical amplifier integrated into the optical circuit.

28. The method of claim 27, wherein the attenuation level is chosen so that the intensity of the optical signals when delivered from the second end of the optical circuit is substantially equal.

29. The method of claim 26, further comprising:
delivering at least a portion of the optical signals from the second end of the optical circuit to an optical add/drop multiplexer.

30. The method of claim 26, further comprising:
switching at least one optical signal between a first and second port on the second side of the optical circuit with an optical switch integrated into the optical circuit.
